(19) United States
(12) Patent Application Publication
(10) Pub. No.: US 2004/0064365 A1
(43) Pub. Date: Apr. 1, 2004

(54) Electronic coupons

(76) Inventors: Johan Sjobl Sjoblom, (US); Alex D'Anci, Vaasa (FI)

Correspondence Address: NIXON & VANDERHYE, PC, 1100 N GLEBE ROAD, 8TH FLOOR, ARLINGTON, VA, 22201-4714, US

(21) Appl. No.: 10/468,074

(22) PCT Filed: Jan. 31, 2002
(86) PCT No.: PCT/US02/02626

(30) Foreign Application Priority Data
Feb. 17, 2001 (GB) 0103949.4

(51) Int. Cl. G06F 17/60

(52) U.S. Cl. 705/14

(57) ABSTRACT

A method of generating and redeeming an electronic coupon for a purchaser. The method comprises the steps of generating an electronic coupon at a central server 5, the coupon being, associated with a purchaser's identity, sending a request for the coupon from a point-of-sale 14 to the central server 5, the request identifying the purchaser; and sending the coupon from the central server 5 to the point-of-sale 14.

### FIELD OF THE INVENTION

The present invention relates to electronic coupons and in particular to a method and system for generating and redeeming electronic coupons.

### BACKGROUND TO THE INVENTION

There exists a demand amongst television viewers, broadcasters, and advertisers for interactive television (iTV). Interactive television will allow individual viewers to participate in television shows, for example as contestants in a game show, without having to attend the studio where the show is being produced, and will allow viewers to request and receive tailored supplementary information (which may be multimedia data) which it is not possible to provide via a conventional terrestrial, satellite, or cable broadcast. Using iTV, broadcasters and advertisers will be able to expand the range of available services, tapping into and collecting information from niche markets.

Interactive television is available today to a very limited extent. One approach is to broadcast multiple channels of information. The channels are decoded by a set top box, and the user may select one or more of the channels for viewing. Using this method, it is possible for example to allow a viewer to select one of several possible camera angles during a televised football match. Another approach requires the provision of a set top box which is connected to the viewer's telephone line. A viewer's selection (or other data) is returned via the phone line to a central server of the television broadcaster. Data may be returned to the viewer via the same phone line or via the broadcast channel. Yet another approach to the provision of interactive television involves the use of mobile telephones and mobile telephone networks. Signals sent to and received by mobile phones may be synchronised with television broadcasts.

In order to encourage interactivity on the part of television viewers, viewers may be rewarded for their interaction with electronic coupons (or “e-coupons). For example, a company may solicit electronic responses during and after the broadcast of a commercial for one of its products. Each response is rewarded with an e-coupon.

### STATEMENT OF THE INVENTION

It is known to send e-coupons to mobile telephones. A phone user may redeem a coupon at a point-of-sale by showing his coupon on the phone's display to a sales assistant—the coupon is typically a reference code. However, this method suffers from the disadvantage that a buyer must have his phone with him at the point-of-sale, and that it is time consuming. It will be appreciated that this problem arises where e-coupons are issued as a result of iTV or of some other activity, e.g. web browsing.

It is an object of the present invention to overcome or at least mitigate the above noted disadvantages of existing interactive television systems. This and other objects are achieved by generating and storing e-coupons at a central site. A coupon is accessed at that site by a point-of-sale when the holder of a coupon makes a purchase or initiates some other form of transaction.

According to a first aspect of the present invention there is provided a method of generating and redeeming an electronic coupon for a purchaser, the method comprising the steps of:

generating an electronic coupon at a central server, the coupon being associated with a purchaser's identity;

sending a request for the coupon from a point-of sale to the central server, the request identifying the purchaser; and

sending the coupon from the central server to the point-of-sale.

The step of generating the electronic coupon may be carried out in response to the receipt at the central server, or at a site coupled to the central server, of a request from the purchaser. Electronic coupons may be generated for all potential purchasers in this manner. The request from the purchaser may arise for example from an interactive television experience, or from the purchaser carrying out some activity over the Internet.

In a preferred embodiment of the invention, the method results from an interactive television or radio broadcast or a webcast. A potential purchaser send a request for the e-coupon over an interactive channel. This channel may comprise a mobile telecommunications network, the purchaser employing a mobile phone to send the coupon request.

The site which receives the coupon request from the purchaser may be synchronised with the television or radio broadcast or webcast to enable the request to be associated with the correct broadcast segment, e.g. a commercial. If this site is not the central server, the identity of the broadcast segment may be used to determine the identity of the central server to which the request should be forwarded. All requests received and associated with a given broadcast segment may be sent in a block to the central server.

The method of the present invention may comprise a step of determining a purchaser identity prior to said step of sending a request for the coupon from a point-of sale to the central server. The purchaser identity may be a name and/or account number read electronically at the point-of-sale from a credit card, debit card, loyalty card or the like. The identity may alternatively be obtained by the point-of-sale over a local wireless connection from a mobile telephone, PDA, or communicator operated by the purchaser.

The e-coupon may identify a discount for a given product, a free product, or some other special offer, e.g. three products for the price of two. The e-coupon may identify a special offer for a service rather than a product, e.g. a hair cut.

The point-of-sale at which the coupon is redeemed may be a shop or other premises at which the purchaser presents himself. Alternatively, the point of sale may be a call centre to which the purchaser calls, or a web server to which the purchaser connects.

Typically, the request for a coupon and the coupon are sent via the Internet, although other transport mechanisms may be used.

### BRIEF DESCRIPTION OF THE DRAWINGS

FIG. 1 illustrates schematically a system for generating and redeeming e-coupons; and

FIGS. 2A and 2B are flow diagrams illustrating a method of operation of the system of FIG. 1.

### DETAILED DESCRIPTION OF A PREFERRED EMBODIMENT

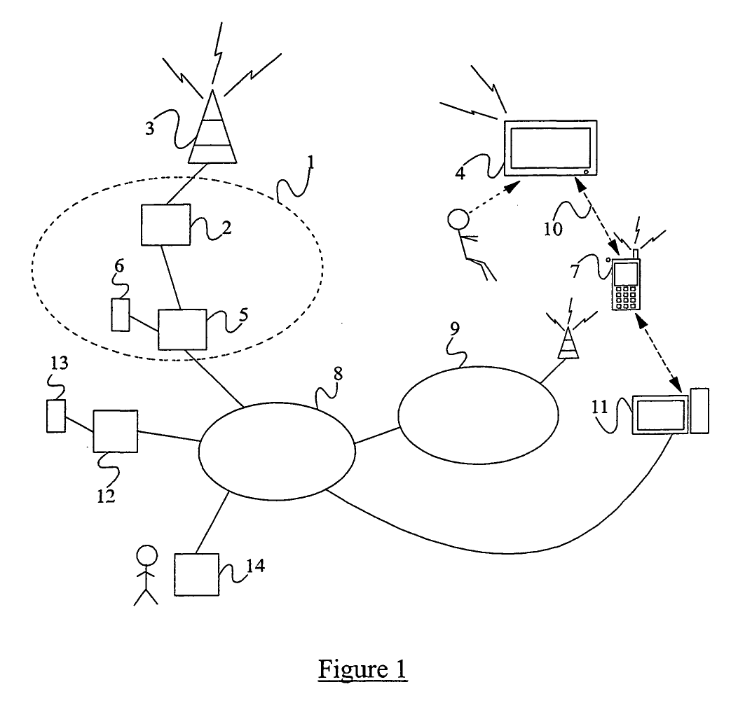

There is illustrated in FIG. 1 a system for providing interactive television. A television corporation 1 broadcasts programmes on a number of different terrestrial, cable, or satellite television channels from a central studio or studios 2 using a set of transmitters 3. Televisions 4 receive the broadcast channels in the usual manner.

The interactive component of television viewing is facilitated by providing an information server 5 which is coupled to the broadcasting studios to receive the broadcast signals (the server may be provided by one or more computers). The broadcast signals contain programme triggers which indicate the beginning and end of a programme (including commercials) and possibly the identity of broadcast programmes. Triggers may also occur during a programme to indicate a specific event. The server 5 is coupled to a database 6 which stores a set of information for each programme to be broadcast (e.g. in a given week). This information is in the form of HTTP or WAP pages (coded using for example, HTML, Compact HTML, XHTML, XML, and/or WML). The server 5 retrieves information from the database 6 according to the triggers contained in the broadcast signals.

A television viewer wishing to participate in an interactive broadcast must be in possession of a wireless device 7 such as a mobile telephone, communicator, or PDA. For the purpose of illustration, the wireless device 7 is assumed to have functionality for accessing the Internet 8 via a mobile telecommunication access network 9 to which the terminal user subscribes. Conventional mobile phone networks (e.g. GSM) may have this functionality. However, Internet access is currently being greatly enhanced by the introduction of services such as GPRS and new networks such as UMTS.

The viewer will select on the mobile terminal 7 the www address (URL) of the television channel (or programme) which he or she is currently viewing. This address may be displayed on the television screen and/or may be pre-programmed into the terminal 7. The selected URL identifies a location at the information server 5. The request for information is sent to the server 5 via the mobile network 9 and the Internet 8. The content at the specified location changes dynamically according to the programme triggers contained in the television signals received by the server 5 from the studio 2. The server 5 returns the current content of the specified location to the terminal 7. By including certain information in the headers of HTTP (and WAP) pages it is possible to force proxies which may be present in the transmission route between the server 5 and the terminal 7 (and at the terminal 7 itself) not to store these pages in their respective caches. This means that requested pages are always obtained from the information server 5, ensuring that the pages are always “fresh”. In some cases, the server 5 may redirect a URL request to some other URL, for example a URL of an e-commerce case in the case that a viewer has clicked a link during the broadcast of a commercial. The server 5 may record the redirection service for the later billing of the sponsor.

The returned page is displayed on a display of the terminal 7 and includes information relevant to the programme being viewed. The page may include further hyperlinks which can be selected by the viewer. Client software or scripts (e.g. EPOC software or ECMAScript) in the wireless terminal 7 may be used to allow the viewer to send data to the server 5, for example answers to questions presented on a game show. The appropriate software or script may be either preinstalled or loaded over the Internet into the terminal 7. Secure exchange mechanisms implemented in a similar manner may allow e-commerce transactions such as betting on broadcast sporting events and the purchase of items advertised in commercials.

Broadcasters or their sponsors may reward the interaction of viewers with electronic coupons, referred to hereinafter as “e-coupons”. An e-coupon will typically represent a monetary value which can be redeemed by a viewer when purchasing a product or service.

Consider for example the case where a commercial for a particular product is broadcast from the studio 2. The viewer selects the appropriate URL (which may be displayed in the corner of his television screen during the commercial), and transmits a request for information from his terminal 7 to the server 5 via the Internet. This request contains the viewer's name and postal code (or other unique identity). At the server 5, the information corresponding to the commercial is retrieved from the database 6. At the same time, the server 5 identifies the corporation responsible for the commercial, and sends a notification to an e-coupon server 12 operated by that corporation and also coupled to the Internet 8, to notify the e-coupon server 12 that a viewer has responded to a commercial. The notification identifies the responding viewer as well as the commercial. The e-coupon server 12 then generates an e-coupon, attaches it to the viewer's identity, and stores it in a database 13. Confirmation that the e-coupon has been generated is returned to the server 5. The server 5 includes the confirmation in the information retrieved from the database 6, and sends the information to the viewer's terminal 7. A message is displayed on the terminal 7 noting that the viewer has been allocated an e-coupon. It will be appreciated that the e-coupon may be generated at the server 5, and subsequently sent to the e-coupon server for storage, or that the server 5 may incorporate the functionality of the e-coupon server 12.

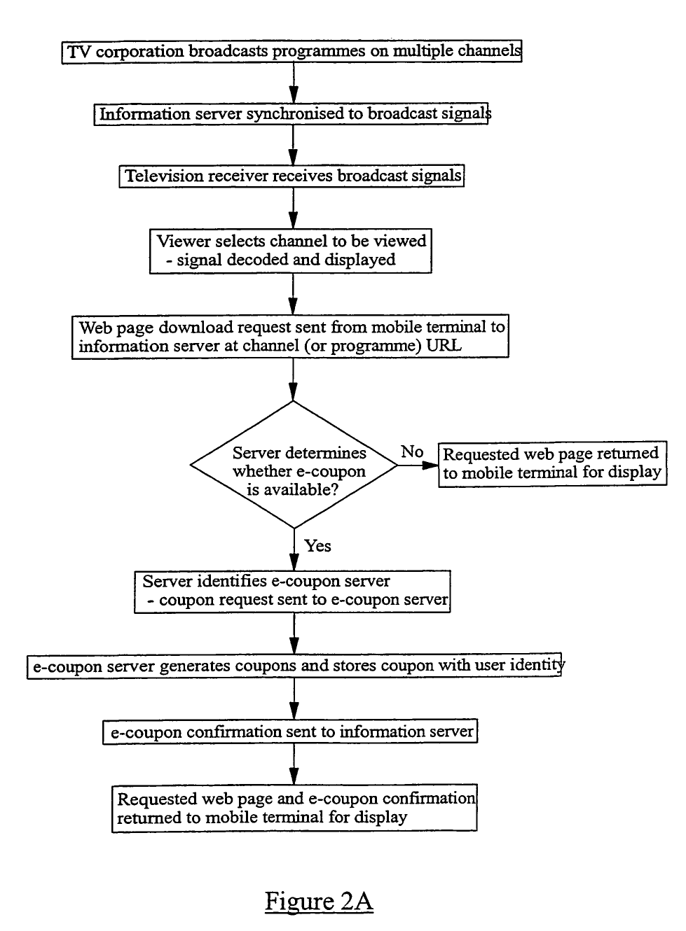

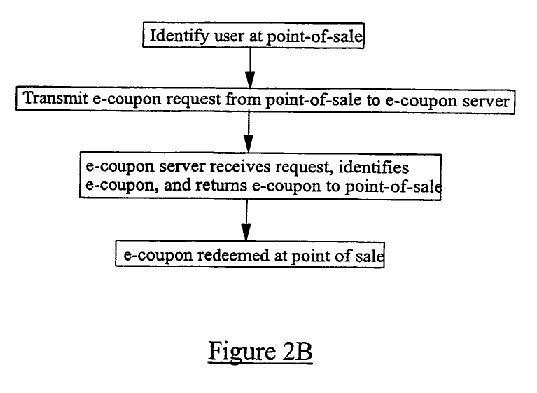

The method of generating the e-coupon is further illustrated by the flow diagram of FIG. 2A.

If the viewer decides to make a purchase, he presents himself to a point-of-sale 14, e.g. a shop, and identifies himself. He may do this verbally, or may do it electronically using a credit card, debit card, shop loyalty card or other means. Another possibility is that identification happens automatically. This may be the case where the purchaser has a Bluetooth™ device (e.g. a mobile telephone) which communicates with a Bluetooth device at the point-of-sale. The point-of-sale is connected to the Internet 8, and sends a request for the allocated e-coupon to the e-coupon server 12 via a secure connection. The request includes the identity of the purchaser. The e-coupon server 12 receives the request, and retrieves the allocated e-coupon. The e-coupon is returned to the point-of-sale 14 over the Internet 8 using the same secure connection. At this point, the value of the e-coupon may be deducted from the sale price of the product being purchased. Alternatively, if the purchaser has a loyalty card, the card may be “charged” with the value of the coupon if the purchaser decides to save the coupon.

The method of redeeming the e-coupon is further illustrated by the flow diagram of FIG. 2B.

It will be appreciated by the person of skill in the art that various modifications may be made to the above described embodiments without departing from the scope of the present invention. For example, a viewer may not wish to identify himself to a corporation. To overcome this problem, the e-coupon server may generate a unique reference number which is associated at the e-coupon server with the viewer. The reference number is then returned to the viewer and stored in his terminal. When the viewer wishes to purchase a product and redeem the coupon, the reference number is given to the point of service for sending to the e-coupon server.

1. A method of generating and redeeming an electronic coupon for a purchaser, the method comprising the steps of:
generating an electronic coupon at a central server, the coupon being associated with a purchaser's identity;
sending a request for the coupon from a point-of sale to the central server, the request identifying the purchaser; and
sending the coupon from the central server to the point-of-sale.

2. A method according to claim 1, wherein the step of generating the electronic coupon is carried out in response to the receipt at the central server, or at a site coupled to the central server, of a request from the purchaser.

3. A method according to claim 1 or 2, wherein the electronic coupon is generated as a result of an interactive television experience, or from the purchaser carrying out some activity over the Internet.

4. A method according to any one of the preceding claims, wherein the electronic coupon is generated as a result of a request for the e-coupon being sent over an interactive channel by a potential purchaser.

5. A method according to claim 4, wherein the interactive channel comprises a mobile telecommunications network, the purchaser employing a wireless device to send the coupon request.

6. A method according to claim 5 or 6, wherein said request contains the identity of the sender.

7. A method according to any one of claims 4 to 6, wherein the site which receives the coupon request from the purchaser is synchronised with the television or radio broadcast or webcast to enable the request to be associated with the correct broadcast segment.

8. A method according to any one of the preceding claims and comprising the step of determining a purchaser identity prior to said step of sending a request for the coupon from a point-of sale to the central server.

9. A method according to any one of the preceding claims, wherein the request for a coupon and the coupon are sent via the Internet.
